(19) United States
(12) Patent Application Publication
(10) Pub. No.: US 2008/0022124 A1
(43) Pub. Date: Jan. 24, 2008

(54) METHODS AND APPARATUS TO OFFLOAD CRYPTOGRAPHIC PROCESSES

(76) Inventors: Vincent J. Zimmer, Federal Way, WA (US); Michael A. Rothman, Puyallup, WA (US); Karanvir Grewal, Hillsboro, OR (US); Gundrala D. Goud, Olympia, WA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/425,897

(22) Filed: Jun. 22, 2006

(51) Int. Cl. G06F 12/14

(52) U.S. Cl. 713/189

(57) ABSTRACT

Methods and apparatus to off-load cryptographic processes are disclosed. An example method includes receiving a request to perform a cryptographic process at a first component of a processor system, transmitting the request over a data bus to a second component of a processor system, receiving the request at the second component, and performing the cryptographic process on the second component. For example, the first component may be a processor and the second component may be a management agent. Other embodiments are described and claimed.

### FIELD OF THE DISCLOSURE

This disclosure relates generally to processor systems and, more particularly, to cryptography in processor systems.

### BACKGROUND

The desire for computer system and data security has led to the development of hardware level security techniques. In particular, cryptography components have been added to system hardware components (e.g., motherboards, processors, network controllers, etc.). The cryptography components are capable of authenticating software to be executed on a system. For example, a cryptography component may authenticate an update for a basic input/output system (BIOS) before allowing the update to be applied. The cryptography components can also authenticate remote access to a computer system. For example, a cryptography component may authenticate an request from a device on a management network (e.g., an out-of-band network) to gain access to a computer system.

Currently, each component of a computer system that needs cryptography functionality is implemented with its own cryptography component. For example, in one system implementation from Intel® Corporation, the system includes several cryptographic components: one in a trusted platform module (TPM), one in an active management technology (AMT) module, and one in a BIOS associated with the system. In other words, three cryptographic components performing similar functions are included.

### BRIEF DESCRIPTION OF THE DRAWINGS

FIG. 1 is a block diagram of an example system including a management agent capable of performing cryptographic processes.

FIG. 2 is a block diagram of an example implementation of the network controller with management agent of FIG. 1.

FIG. 3 is a flowchart representative of an example process to implement the management agent of FIG. 2.

FIG. 4 is a list of interface protocols/instructions that may be made available by the interface of the management agent 210 of FIG. 2.

### DETAILED DESCRIPTION

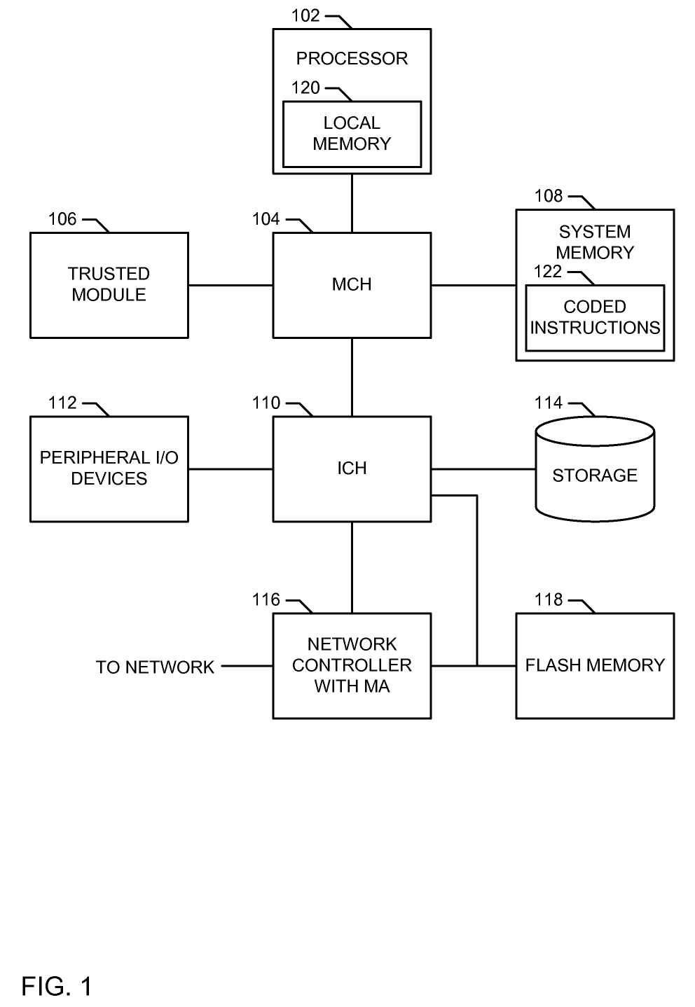

FIG. 1 is a block diagram of an example system 100 including a management agent capable of performing cryptographic processes. In general, a management agent associated with one or more of the blocks of system 100 includes an interface that allows system level software and firmware (e.g., pre-operating system software, runtime management mode firmware, etc.) to instruct the management agent to perform cryptographic processes (e.g., generating security keys, data encryption and/or decryption, data certification and/or verification, identity authentication and/or verification, software authentication and/or verification, etc.). The management agent is capable of executing exclusive of and/or simultaneously with a processor of the system 100. In other words, if system level software, firmware, or hardware requires performance of a cryptographic process, the management agent can perform the cryptographic process while the central processing unit continues to execute further instructions.

The example system 100 includes a processor 102, a memory controller hub (MCH) 104, a trusted module (TM) 106, a random access memory (RAM) 108, integrated controller hub (ICH) 110, peripheral input/output (I/O) devices 112, a storage 114, a network controller with a management agent (MA) 116, and flash memory 118.

The processor 102 can be implemented using one or more Intel® microprocessors from the Pentium® family, the Itanium® family, the XScale® family, or the Centrino™ family. Of course, other processors from other families and/or other manufacturers are also appropriate. While the example system 100 is described as having a single processor 102, the system 100 may alternatively have multiple processors. The processor 102 includes a local memory 120, and executes coded instructions present in the local memory 120, coded instructions 122 present in the system memory 108, and/or coded instructions in another memory device. The processor 102 may also execute firmware instructions stored in the flash memory 118 or any other instructions transmitted to the processor 102.

In the example of FIG. 1, the processor 102 is coupled with the MCH 104. The MCH 104 provides an interface to the TM 106 and system memory 108. The MCH 104 is also coupled with the ICH 110.

The TM 106 provides security and/or cryptographic functionality. In one example, the TM 106 may be implemented as a trusted platform module (TPM). TM 106 provides a secure identifier, for example, a cryptographic key in a secure manner to the MCH 104, or any other component of the system 100.

The system memory 108 may be any volatile and/or non-volatile memory that is connected to the MCH 104 via, for example, a bus. For example, volatile memory may be implemented by Synchronous Dynamic Random Access Memory (SDRAM), Dynamic Random Access Memory (DRAM), RAMBUS Dynamic Random Access Memory (RDRAM), and/or any other type of random access memory device. Non-volatile memory may be implemented by flash memory and/or any other desired type of memory device.

The ICH 110 provides an interface to the peripheral I/O devices 112, the storage 114, the network controller with MA 116, and the flash memory 118. The ICH 110 may be connected to the network controller with MA 116 using a peripheral component interconnect (PCI) express (PCIe) interface or any other available interface.

The peripheral I/O devices 112 may include any number of input devices and/or any number of output devices. The input device(s) permit a user to enter data and commands into the system 100. The input device(s) can be implemented by, for example, a keyboard, a mouse, a touchscreen, a track-pad, a trackball, isopoint and/or a voice recognition system. The output devices can be implemented, for example, by display devices (e.g., a liquid crystal display, a cathode ray tube display (CRT), a printer and/or speakers). The peripheral I/O devices 112, thus, typically include a graphics driver card. The peripheral I/O devices 112 also include a communication device such as a modem or network interface card to facilitate exchange of data with external computers via a network (e.g., an Ethernet connection, a digital subscriber line (DSL), a telephone line, coaxial cable, a cellular telephone system, etc.).

The storage 114 is one or more storage device(s) storing software and data. Examples of storage 114 include floppy disk drives, hard drive disks, compact disk drives, and digital versatile disk (DVD) drives.

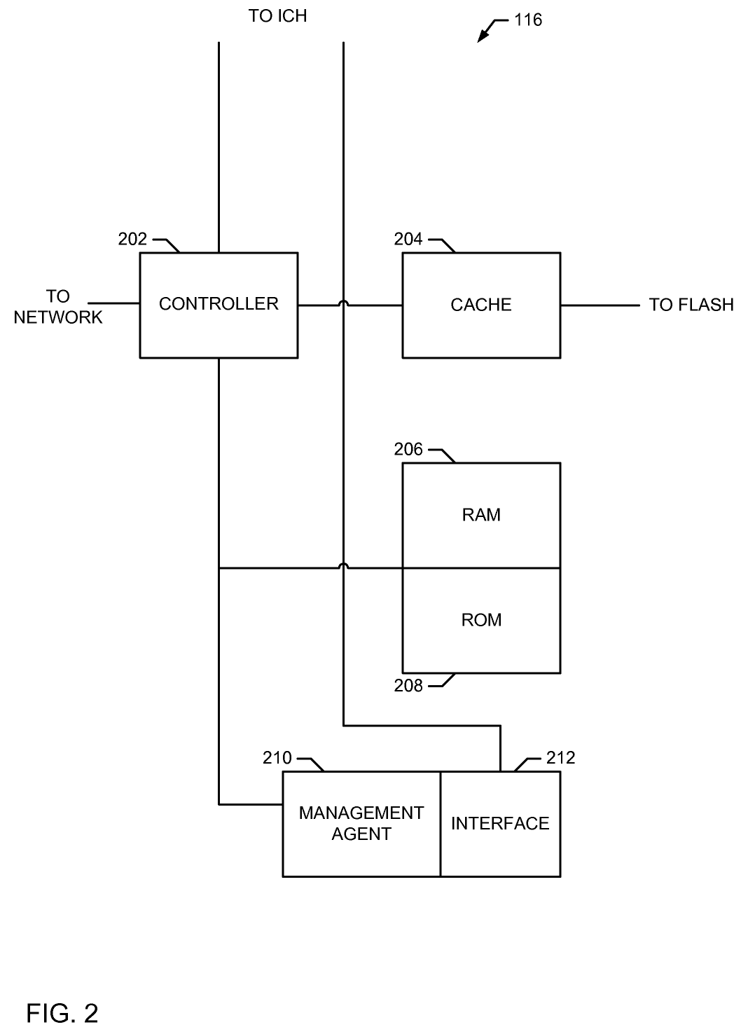

The network controller with MA 116 provides an interface to an external network. The network may be any type of wired or wireless network connecting two or more computers. The network controller with MA 116 also includes a management agent housing the ability to perform cryptographic processes. In addition, the network controller with MA 116 includes an interface that allows system software (e.g., basic input/output system (BIOS) software, pre-operating system software, runtime management mode software, etc.) to instruct the network controller with MA 116 to perform cryptographic processes on behalf of the system software. The network controller with MA 116 may operate independently of the operation of the processor 102. For example, the network controller with MA 116 may include a microprocessor, a microcontroller or other type of processor circuitry, memory, and interface logic. One example implementation of the network controller with MA 116 is the Tekoa Management controller within the Pro1000 Gigabit Ethernet controller from Intel® Corporation. The network controller with MA 116 is described in further detail in conjunction with the description of FIG. 2.

The flash memory 118 is a system memory storing instructions and/or data (e.g., instructions for initializing the system 100). For example, the flash memory 118 may store BIOS software. The BIOS software may be an implementation of the Extensible Firmware Interface (EFI) as defined by the EFI Specifications, version 2.0, published January 2006, available from the Unified EFI Forum. The flash memory 118 may be coupled to the network control with MA 116 using a serial peripheral interface (SPI) or any other available interface. The instructions stored in the flash memory 118 are capable of transmitting requests to perform cryptographic processes to the network controller with MA 116 and receiving the result of such requests. In the example system 100, the flash memory 118 also stores data and/or instructions for use by the network controller with MA 116.

FIG. 2 is a block diagram of an example implementation of the network controller with MA 116 of FIG. 1. The example network controller with MA 116 includes a controller 202, a cache 204, random access memory (RAM) 206, read-only memory (ROM) 208, a management agent 210, and an interface 212.

The controller 202 controls the operation of the network controller with MA 116. The controller 202 may be any processor, microprocessor, microcontroller, logic, etc. The controller 202 may execute instructions stored in any of the cache 204 (e.g., instructions retrieved from the flash memory 118 of FIG. 1), the RAM 206, or the ROM 208.

The example cache 204 is a temporary storage for data and/or instructions to be executed by the controller 202. The cache 204 may be implemented by any type of volatile or non-volatile memory. The cache 204 is coupled with the flash memory 118 of FIG. 1 so that the flash may mirror data and/or instructions from the flash memory 118. In other words, the cache 204 provides temporary storage of data and/or instructions from the flash memory 118 to enable faster access to the data and/or instructions by the controller 202. The cache 204 may be coupled to the flash memory 118 via a SPI or any other type of interface.

The RAM 206 and/or ROM 208 store instructions to be executed by the controller 202 to implement the network controller with MA 116. The RAM 206 and ROM 208 may be implemented by any volatile and/or non-volatile memory. For example, volatile memory may be implemented by Synchronous Dynamic Random Access Memory (SDRAM), Dynamic Random Access Memory (DRAM), RAMBUS Dynamic Random Access Memory (RDRAM) and/or any other type of random access memory device. Non-volatile memory may be implemented by flash memory and/or any other desired type of memory device.

The management agent 210 performs cryptographic processes. For example, the cryptographic processes may include generating security keys, data encryption and/or decryption, data certification and/or verification, identity authentication and/or verification, software authentication and/or verification, etc. The management agent 210 may utilize any available encryption scheme such as, for example, the advanced encryption standard (AES), the Rivest-Shamir-Adleman (RSA) standard, the elliptic curve cryptography (ECC) signature standard, the RC4 standard, the Transport Layer Security (TLS) standard (Request for Comments (RFC) 2246 from the Internet Society), the secure socket layer (SSL) standard, the extensible authentication methods (EAP) standard, the protected extensible authentication protocol (PEAP) standard, etc. The example management agent 210 is implemented by the active management technology (AMT) provided by Intel® Corporation. However, any type of management agent may be used.

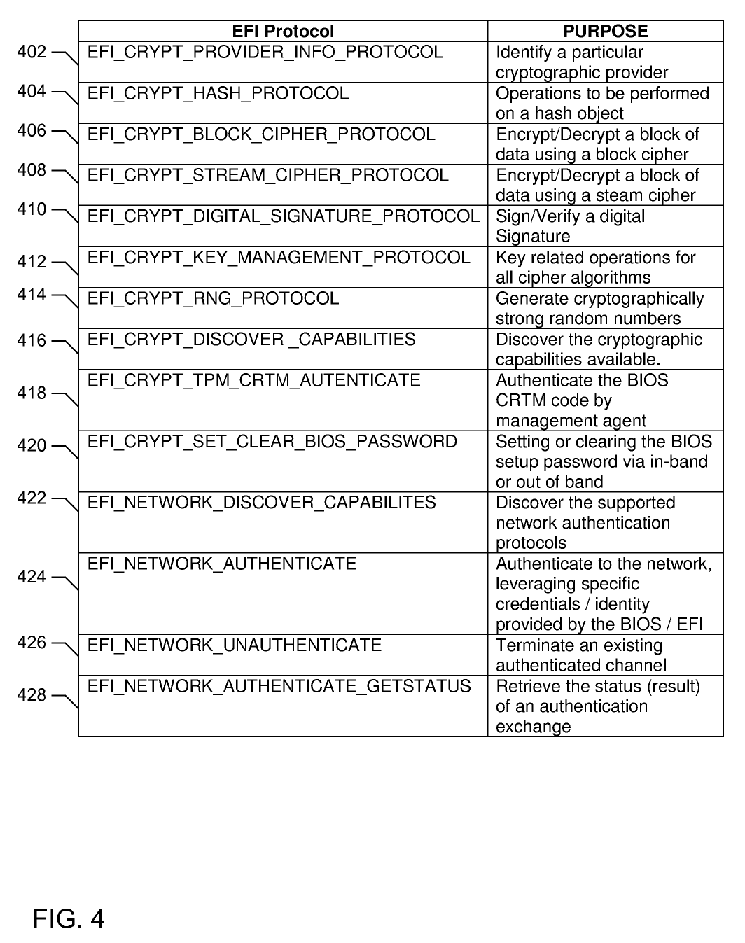

While the management agent 210 is illustrated as a component that is separate from the controller 202, persons of ordinary skill in the art will recognize that the management agent 210 may be integrated with the controller 210. In addition, as is shown in FIG. 4, the management agent 210 may be provided in components other than the network controller with MA 116. As previously mentioned, while the management agent 210 is located in the network controller with MA 116, a management agent may additionally or alternatively be located in other components of the system 100. For example, the management agent may be located in the MCH 104 of FIG. 1. Additionally or alternatively, a management agent and interface for pre-operating system or runtime management mode firmware may be provided as a hardware partition, or a virtual machine monitor (VMM)).

The management agent 210 includes an interface 212 that allows pre-operating system software or runtime management mode firmware to request that the management agent 210 perform a cryptographic process. In particular, in the disclosed example, the interface receives a request (e.g., requests from the processor 102 of FIG. 1) via a bus (e.g., a PCIe bus between the ICH 110 and the network controller with MA 116). The interface 212 acts as a proxy for the request by passing the request to the management agent 210. For example, an EFI BIOS stored in the flash memory 118 of FIG. 1 and executed by the processor 102 may transmit instructions to the management agent 210 via the interface 212. The example interface 212 is an application program interface (API). The API provides a level of abstraction between the management agent 210 and request and exposes some or all of the functions of the management agent 210, allowing them to be accessed (e.g., called) by other components (e.g., the processor 102 of FIG. 1) of the system 100. However, alternatively, the interface 212 may utilize any method for providing access to the management agent 210.

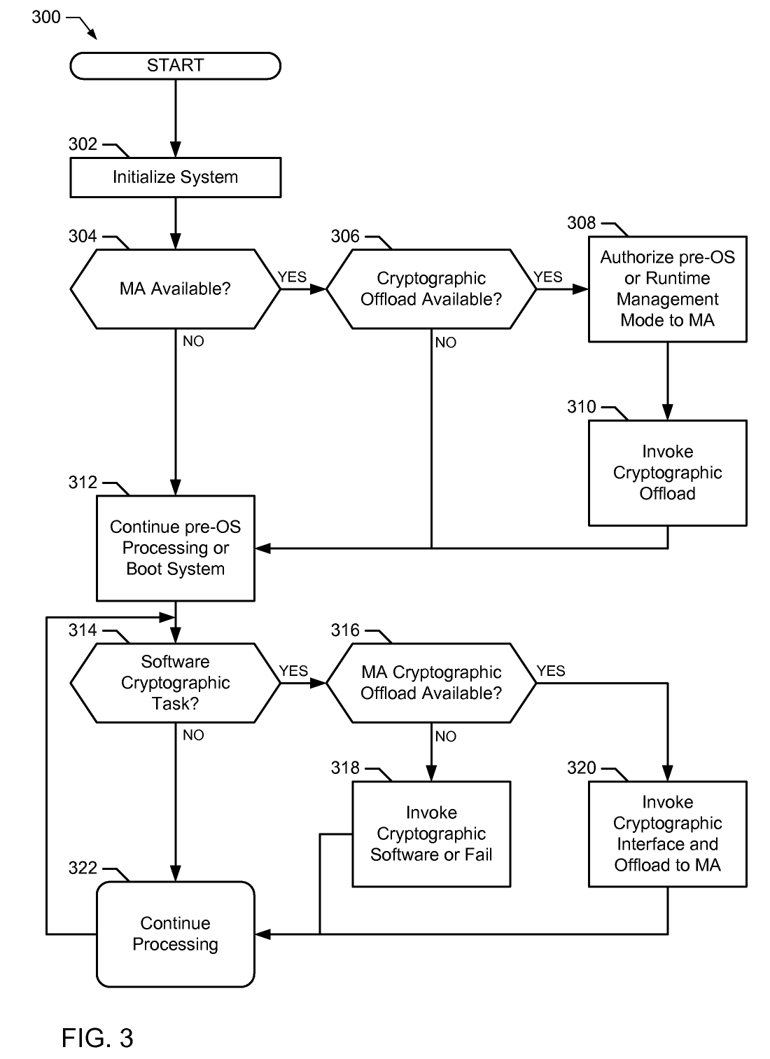

Having described the architecture of one example system that may be used to provide dynamic messaging services, various processes are described in FIG. 3. Although the following discloses example processes, it should be noted that these processes may be implemented in any suitable manner. For example, the processes may be implemented using, among other components, software, or firmware executed on hardware. However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.) exclusively in software, exclusively in firmware, or some combination of hardware, firmware, and/or software. Additionally, some portions of the process may be carried out manually. Furthermore, while each of the processes described herein is shown in a particular order, those having ordinary skill in the art will readily recognize that such an ordering is merely one example and numerous other orders exist. Accordingly, while the following describes example processes, persons of ordinary skill in the art will readily appreciate that the examples are not the only way to implement such processes.

FIG. 3 is a flowchart representative of an example process 300 to implement the management agent 210 of FIG. 2. The process of FIG. 3 begins when the system 100 starts. For example, the process may begin when the system 100 is first powered on or when the system 100 is reset. During startup, boot instructions are executed by the processor 102 to initialize the system (block 302). For example, the instructions may be EFI BIOS instructions stored in the flash memory 118. During initialization, the system 100 determines if a management agent is available (block 304). For example, the system may determine if the management agent 210 is available by querying a list of available system components/resources. This detection can occur via a query from the in-band BIOS to the out-of-band management controller through the host interface, which includes but is not limited to the KCS (Keyboard Controller Style Interface) with it's ISA-style command/status register interface or the HECI (Host Embedded Controller Interface) with its PCI-based interface. If a management agent is not available control proceeds to block 312, which is described below.

If a management agent (e.g., the management agent 210) is available, the system 100 determines if cryptographic off-load capabilities are available (block 306). In other words, the system 100 determines if the available management agent 210 includes an interface (e.g., the interface 212) that allows the instructions to instruct the management agent 210 to perform cryptographic processes. In one example implementation, the processor 102 attempts to access the interface 212 of the management agent 210. If the access is successful, it is determined that the system 100 includes an interface to the management agent 210. If cryptographic off-load capabilities are not available, control proceeds to block 312.

If cryptographic off-load capabilities are available (block 306), the management agent 210 authorizes the pre-operation system software (e.g., EFI, BIOS, etc.) and/or runtime management mode firmware (e.g., SMM firmware to request the performance of cryptographic processes (block 308). The management agent 210 then invokes cryptographic off-load by instructing the system 100 to transmit cryptographic process requests to the management agent 210 (block 310). For example, when the processor 102 receives a call to the management agent 210, the processor 102 transmits the call via the MCH 104 and the ICH 110 to the network controller with MA 116. The processor 102 may continue to execute further instructions while the network controller with MA 116 handles the call. This allows for an asynchronous command model wherein the BIOS does not have to block while the network controller with the MA 116 processes the operation.

After determining that a management agent is not available (block 304), an available management agent does not support cryptographic capabilities (block 306), or initializing cryptographic off-load (blocks 308, 310), the system 100 continues pre-operating system processing and booting (block 312). For example, the system 100 may perform several pre-operating system instructions and then load an operating system.

Throughout the operation of the system 100, the system 100 determines if a process or task to be executed by pre-operating system software and/or runtime management mode firmware executing on the processor 102 is a request for performance of a cryptographic process (block 314). If a process or task to be executed is not a request for performance of a cryptographic process (block 316), the system 100 continues processing (block 322). If a process or task to be executed is a request for performance of a cryptographic process, the system 100 determines if a management agent with cryptographic off-load capability is available (block 316). If a management agent with cryptographic off-load capability is not available, the system 100 instructs the processor 102 to execute software instructions to perform the cryptographic process (block 318). Control, then proceeds to block 322 to continue processing.

If a management agent with cryptographic off-load capability is available, the request for performance of a cryptographic process is directed to the interface of the available management agent (e.g., the interface 212 of the management agent 210) (block 320). In other words, the cryptographic process is performed by the management agent 210. While the management agent is performing the cryptographic process, the processor 102 may continue executing instructions associated with the system 100 as part of block 322. Alternatively, after performance of the cryptographic process is complete, control proceeds to block 322.

FIG. 4 is a list of interface protocols/instructions that may be made available by the interface 212 of the management agent 210 of FIG. 2 where the management agent 210 is implemented by an AMT from Intel® Corporation. Protocols 402-420 are associated with AMT functions. Protocols 420-428 are associated with network authentication functions.

The protocol 402 (EFI_CRYPT_PROVIDER_INFO_PROTOCOL) retrieves identity information associated with a particular cryptographic provider.

The protocol 404 (EFI_CRYPT_HASH_PROTOCOL) provides operations to be performed on a hash object, such as MD5, SHA-1, SHA-256, or SHA-512.

The protocol 406 (EFI_CRYPT_BLOCK_CIPHER_PROTOCOL) provides operations for encrypting and decrypting a block of data using a block cipher, such as 3DES or AES.

The protocol 408 (EFI_CRYPT_STREAM_CIPHER_PROTOCOL) provides operations for encrypting and decrypting a block of data using a stream cipher, such as RC4.

The protocol 410 (EFI_CRYPT_DIGITAL_SIGNATURE_PROTOCOL) provides operations for signing and verifying a digital signature, such as RSA, DSA, or ECDSA.

The protocol 412 (EFI_CRYPT_KEY_MANAGEMENT_PROTOCOL) provides operations for managing and handling security keys for all available cipher algorithms.

The protocol 414 (EFI_CRYPT_RNG_PROTOCOL) provides operations for generating cryptographically strong random numbers for use in other cryptographic and security operations.

The protocol 416 (EFI_CRYPT_DISCOVER_CAPABILITIES) retrieves/generates a list of available cryptographic capabilities for the system.

The protocol 418 (EFI_CRYPT_TPM_CRTM_AUTENTICATE) authenticates the basic input/output system (BIOS) core root of trust management (CRTM) at the management agent 210.

The protocol 420 (EFI_CRYPT_SET_CLEAR_BIOS_PASSWORD) provides operations for setting or clearing the BIOS setup password. This operation may be performed via an in-band request from the system 100 or from a remote out-of-band system.

The protocol 422 (EFI_NETWORK_DISCOVER_CAPABILITES) retrieves/generates a list of supported authentication protocols associated with a connected network.

The protocol 424 (EFI_NETWORK_AUTHENTICATE) authenticates the requesting system to the a connected network. The protocol 424 may use credentials associated with the management agent or any other credentials associated with the system 100 (e.g., provided by the BIOS, EFI, etc.).

The protocol 426 (EFI_NETWORK_UNAUTHENTICATE) terminates an existing authentication session to disassociated the system from a connected network.

The protocol 428 (EFI_NETWORK_AUTHENTICATE_GETSTATUS) retrieves the current status of an authentication session/exchange.

As an alternative to implementing the methods and/or apparatus described herein in a system such as the device of FIG. 1, the methods and/or apparatus described herein may alternatively be embedded in a structure such as a processor and/or an ASIC (application specific integrated circuit).

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents. For example, the order of execution of the blocks of FIG. 3 may be changed and/or blocks may be added or omitted.

What is claimed is:

1. A method comprising:
receiving a request associated with at least one of a pre-operating system software or a runtime management mode firmware to perform a cryptographic process at a first component of a processor system;
transmitting the request over a data bus to a second component of a processor system;
receiving the request at the second component; and
performing the cryptographic process on the second component.

2. A method as defined in claim 1, further comprising determining if the system includes a second component capable of receiving a request to perform a cryptographic process over a data bus and capable of performing the cryptographic process.

3. A method as defined in claim 1, wherein the second component is a management agent.

4. A method as defined in claim 1, wherein the bus is a peripheral component interconnect express bus.

5. A method as defined in claim 1, wherein the first component is a processor.

6. A method as defined in claim 1, wherein the second component is connected to an integrated controller hub and the request is transmitted to the second component via the integrated controller hub.

7. A method as defined in claim 1, wherein the runtime management mode is at least one of an extensible firmware interface runtime mode or a system management mode.

8. A method as defined in claim 1, wherein the pre-operating system software is a basic input/output system or an extensible firmware interface.

9. A method as defined in claim 1, wherein the second component is associated with a network controller.

10. A method as defined in claim 9, wherein the network controller is associated with an out-of-band network.

11. A method as defined in claim 1, wherein the second component is associated with a memory control hub.

12. A method as defined in claim 1, further comprising authorizing at least one of a pre-operating system software or a runtime management mode firmware to request performance of the cryptographic process at the second component.

13. A method as defined in claim 1, wherein the cryptographic process is at least one of identifying a cryptographic provider, operating on a hash object, encrypting a block of data using a block cipher, decrypting a block of data using a steam cipher, encrypting a block of data using a block steam, decrypting a block of data using a block cipher, signing a digital signature, verifying a digital signature, performing a key related operation for a cipher algorithm, generating a cryptographically strong random number, discovering available cryptographic capabilities, authenticating a basic input/output core root of trust management code at the second component, setting a basic input/output setup password, clearing a basic input/output setup password, discovering supported network authentication protocols, authenticating to a network, terminating an existing authenticated channel, or retrieving a status of an authentication change.

14. A method as defined in claim 1, further comprising executing an instruction on the first component while performing the cryptographic process on the second component.

15. A machine-accessible medium having a plurality of machine accessible instructions that, when executed, cause a machine to:
receive a request associated with at least one of a pre-operating system software or a runtime management mode firmware to perform a cryptographic process at a first component of a processor system;
transmit the request over a data bus to a second component of a processor system;
receive the request at the second component; and
perform the cryptographic process on the second component.

16. A machine-accessible medium as defined by claim 15, further comprising instructions that, when executed, cause the machine to determine if the system includes a second component capable of receiving a request to perform a cryptographic process over a data bus and capable of performing the cryptographic process.

17. A machine-accessible medium as defined by claim 15, wherein the second component is a management agent.

18. A machine-accessible medium as defined by claim 15, wherein the bus is a peripheral component interconnect express bus.

19. An apparatus comprising:
a first component of a processor system to receive a request associated with at least one of a pre-operating system software or a runtime management mode firmware to perform a cryptographic process and to transmit the request over a data bus; and
a second component of a processor system to receive the request at the second component and to perform the cryptographic process.

20. An apparatus as defined in claim 19, wherein the first component is further to determine if the second component is capable of receiving a request to perform a cryptographic process over a data bus and capable of performing the cryptographic process.

21. An apparatus as defined in claim 19, wherein the first component is a processor and the second component is a management agent.

22. An apparatus as defined in claim 19, wherein the bus is a peripheral component interconnect express bus.

23. An apparatus as defined in claim 19, further comprising an integrated controller hub connected to the second component.

24. An apparatus as defined in claim 23, further comprising a memory controller hub connected to the integrated controller hub and the first component.

25. An apparatus as defined in claim 20, wherein the second component is associated with an out-of-band network controller.

26. An apparatus as defined in claim 20, wherein the first component is further to execute an instruction while the second component is performing the cryptographic process.
